(19) United States
(12) Patent Application Publication
(10) Pub. No.: US 2005/0277383 A1
(43) Pub. Date: Dec. 15, 2005

(54) Trunking tone remote adapter and method for using the same

(76) Inventor: Jeffrey T. Reid, Sinking Spring, PA (US)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/864,866

(22) Filed: Jun. 10, 2004

(51) Int. Cl. H04B 7/14

(52) U.S. Cl. 455/15

(57) ABSTRACT

A system and method are provided for operating a trunking radio system by a console for a conventional radio system. The method comprises the steps of defining a system/group table in a trunking tone remote adapter, receiving at the trunking tone remote adapter a tone sequence from at least one of the console, local desk-set or a remote desk-set, and decoding a function tone at the trunking tone remote adapter from the tone sequence. The method for operating the trunking radio system further comprises mapping the function tone received from the console to the defined system/group table to determine the executable function by the trunking tone remote adapter and controlling the trunking radio system according to the executable function by the trunking tone remote adapter.

### BACKGROUND OF THE INVENTION

1. Field of the Invention

The present invention relates to control systems for trunking radio systems. More particularly, the present invention relates to a system and method of controlling a trunking radio system from either a trunking radio system desk-set or a conventional radio system console.

2. Description of the Related Art

As will be discussed below, difficulties exist when combining conventional radio system equipment with trunking radio system equipment. These two different systems shall first be described, followed by more detailed descriptions of the drawbacks and limitations of each, and the difficulties associated with combining them.

Trunking radio systems have developed as a means for providing increased mobile unit capacity in systems which operate in fixed geographic areas. Trunking radio systems employ the sharing of a limited number of communication channels (e.g., repeaters) with a large number of subscriber units. Accordingly, no repeater is dedicated to the sole use of a specific subscriber unit or group of subscriber units. The channel resources are dynamically allocated to satisfy the current communication demands of the subscriber units. Typically, a subscriber unit is a mobile vehicle such as a taxicab, company vehicle or fleet vehicle, or individuals who desire vehicular communication. In many of these situations, it is desirable to have a home or base dispatcher communicate with several mobile units in the field. Trunking radio systems, however, lack full console control, such as the ability to talk to more than one group at a time, or to easily change or reassign groups. A group is a merely an identified collection of radio users.

Control consoles have been interfaced to conventional channel communication systems (hereinafter conventional radio systems) in the past. In contrast, with a trunking radio system, each unit in a conventional radio system is constrained to operate only on a predetermined channel at any given time. Accordingly, since communications with a particular unit only takes place through a predetermined repeater, the console is typically hard-wired to the repeaters to control all of their functions. Thus, the console operator, when selecting a group with which to communicate, controls the function of the repeater on which the group resides. The conventional radio system, as compared to a trunking radio system is spectrally inefficient since the channel remains idle unless a particular unit is communicating during any particular time. Further, the capacity of a particular group may be limited, since all units are required to remain on the same channel. If a first group grows to exceed the capacity of the channel, the units are not easily transferred to a second channel to spread the communication demand across the available channels. Therefore, while trunking radio systems lack full console control, they are more spectrally efficient and more easily accommodate the dynamically varying communication channel demands of its subscriber units.

FIG. 1 is a block diagram of a trunking radio system 100 consisting of a plurality of trunking repeaters 2, each having a receiver section 6 and a transmitter section 4, a plurality of subscriber units 14 (although only one is shown in FIG. 1), which may be either mobile or portable units, a trunking controller 12, and a local trunking desk-set 30. The trunking controller 12 is coupled to the plurality of trunking repeaters 2 via a receive data bus 10 and a transmit data bus 8. The trunking controller 12 communicates with the plurality of subscriber units 14 on a selected one of the trunking repeaters 2 which operates as a control channel. The remainder of the plurality of trunking repeaters 2 are available as assignable voice channels. In the quiescent state, all subscriber units 14 monitor the outbound frequency of the selected trunking repeater which is designated as the control channel.

Control of trunking radio systems today is typically done via digital control signals or sequential tone control. In both cases, the protocol used is proprietary to a particular manufacturer. The proprietary nature of the protocol requires a device at the dispatch location (e.g., a trunking desk-set) that can generate the proprietary protocol based on input from a dispatcher, and a device at the base station (e.g., something similar to the trunking controller 12) that can decode the proprietary protocol and output the necessary signals to control the trunking radio system.

By way of an example, to establish a dispatch call between a group of units operating on the trunking radio system 100, a requesting subscriber unit 14 sends a data packet called an “inbound signalling word” (ISW). The ISW contains the requesting unit's unique ID code, consisting of a group ID, an individual ID, and a subgroup code indicating the group of units the requester wishes to communicate with. The ISW also contains a unique call type code which indicates that a dispatch call is the type of call desired. The request is forwarded to the trunking controller 12 which decodes the request and transmits a data packet called an “outbound signalling word” (OSW) to all subscriber units 14 which are monitoring the outbound control channel. The OSW is a channel grant which contains the subgroup code, the requesting unit's ID code, and the voice channel assigned for the conversation. Following receipt of the OSW, the requesting subscribing unit 14 moves to the assigned voice channel and commences transmitting. Consequently, the subscriber units 14 with matching group or subgroup ID's move to the assigned voice channel as listening units. In this way, a group or subgroup conversation is set up. If all the voice channels are in use, the trunking controller 12 sends the requesting subscriber unit 14 a “busy OSW”.

A dispatcher establishes a call in the same manner as the subscriber unit 14 described hereinabove by using local trunking desk-set 30. Similarly, if all channels are in use, the dispatcher would receive a “busy OSW” and have to wait for an available channel. Further, if the call initiated by a subscriber unit 14 was an individual call (i.e., not a group or subgroup call), the dispatcher cannot monitor the conversation since the dispatcher was not addressed as a listening unit.

A trunking radio system channel scheme can also be divided into talk groups. A talk group (TG) is a collection of channels to be used “exclusively” by a certain group of users. For example, 100 subscriber units 14 in FIG. 1 could be members of the city's police department. They could be pre-allocated channels 1-3 (transmitter-receiver pairs T₁-R₁ through T₃-R₃) for their exclusive use. The fire department can then be allocated the remaining two channels, channels 4 and 5 (transmitter-receiver pairs T₄-R₄ and T₅-R₅). This can make channel selection easier, and thus more efficient. It is also possible for multiple groups to use a single TG (e.g., paramedics can also use the same channels as the firefighters), or to reassign channels for special situations in the event they are needed rapidly. Examples of such a situation is if paramedics, police, and firefighters are responding to a major fire; then, communications between members of the different groups becomes very important.

Referring now to FIG. 2, there is shown a conventional channel radio communication (conventional radio) system 150 consisting of a console network 21, which may have one or more dispatcher positions, a plurality of base units 16, each having a transmitter section 18 and a receiver section 20. The conventional radio system 150 may also have a plurality of mobile units 24 and 26, which communicate with the console network 21 over predetermined communication channels. For example, first mobile unit 24 communicates with the console network 21 through the base unit 16 which has similarly assigned transmit and receive frequencies. In a similar manner, second mobile unit 26 communicates with the console network 21 through the base unit 16 having like frequency assignments. In the conventional radio system 150, it is not possible for first mobile unit 24 to communicate through any other base unit 16 having a different transmit and frequency assignment without being returned to a field service station for transmitter-receiver modifications.

Those skilled in the art of land-mobile radio (LMR) systems can appreciate that a tone-remote adapter can be used to remotely control a base-station radio (or a base unit 16) from a significant distance. This can be accomplished, for example, over a single pair of telephone wires. In the LMR console market, practically all consoles offered by the major manufacturers offer tone-remote control on a per channel basis for conventional radio control. Typically, a single console channel can control or steer 16 different radio channels using logic outputs from the tone-remote adapter.

In a conventional non-trunking radio system, consoles are used by individuals to control the base-station radio. If the base-station radio is adjacent to the console, the console is connected to the conventional base-station radio directly. As is often the case, however, the conventional base-station radio is connected directly to a tone-remote adapter (TRA) 28. FIG. 3 is a block diagram of a conventional radio system 150 utilizing a tone remote adapter 28. The tone remote adapter 28 controls the conventional radio system 150 by discrete logic level signals, and communicates with the consoles 22 using conventional tone control signals. Note that each base unit 16 requires its own trunking remote adapter 28.

In conventional radio systems 150 that use tone-remote dispatch systems, a standard tone sequence has been adopted by many manufacturers and has been designed into most dispatch equipment. Like the digital system described above in regard to trunking radio systems 100, the conventional dispatch system requires a device at the dispatch location (e.g., console 22) that can generate the standard tone sequence based on an input from the dispatcher, and a device at the base station (tone remote adapter 28) that can decode this standard tone sequence and output the necessary signals to control the conventional radio system 150.

As frequency allocation by the FCC changes, and licensing of radio frequencies increases in cost, owners of conventional radio systems 150 are migrating to trunking radio systems 100. Trunking radio systems 100 allow more efficient use of fewer numbers of radio frequencies than conventional radio systems 150 since each RF frequency is shared among many users. The cost of migrating to a new trunking radio system 100 today usual requires the replacement of infrastructure equipment, field equipment and dispatch equipment. Of these, replacement of the dispatch equipment is the most burdensome, in that not only does the new trunking radio system 100 require new dispatch equipment (i.e., trunking desk-sets 30, 32), but also that the dispatch operators must be trained on the new dispatch equipment. The change of the infrastructure and field equipment is relatively transparent, although it too can be monetarily expensive as well.

It is not uncommon that a dispatcher have several dispatch channels to control at any given time. Furthermore, these channels may be a mixture of trunked and conventional channels. When trunked channels are introduced into the conventional system, as discussed above, the addition of new dispatch equipment is required. This is in addition to the equipment the dispatch operator is already familiar with. Some low-to-mid tier consoles do not directly interface to a trunking controller, but rather to a mobile subscriber unit that has the proper interface to control the radio (RS232, 485, among others). Higher tier consoles, i.e., the more expensive ones, do directly interface with to trunking controllers, but these are proprietary and do not necessarily interface with more than one manufacturer's trunking controller. Furthermore, if the operator is using a console to control the conventional channels, this additional equipment is not associated with the console. In addition to the unfamiliarity of the new equipment, the operator now has two devices to operate.

FIG. 4 illustrates an alternative arrangement to the trunking radio system 100 and the conventional radio system 150 of FIG. 3, wherein the trunking radio system 100 uses both a local trunking desk-set 30 and a remote trunking desk-set 32 with a termination panel 34 and a conventional radio system using a conventional console 22. As trunking radio systems 100 take greater portions of market share over conventional radio systems 150, manufacturers are being forced to develop remote control devices to control these radios. Typically, these are in the format of local trunking desk-sets 30, 32, and involve local control or complex proprietary protocols that a low to mid-tier console 22 available today simply cannot do. This has forced customers with conventional consoles 22 to install a trunking desk-set 30, 32 next to the console 22 in order to communicate on these trunking radios systems 100. Of course, very few high-tier consoles 22 may exist that offer trunking control of a trunking radio, but these are limited in the number of trunking control features it supports, and the prices are generally high. Further, the console 22 may only be able to control one manufacturer's trunking radio.

As discussed above, if a customer begins to add a trunking radio system 100 to a conventional radio system 150, there is a problem because the conventional console 22 cannot control the trunking radio system 100 directly or through the tone remote adapter 28. Thus, customers who purchase a trunking radio system 100 to replace their conventional radio system 150 must purchase either or both a local or remote trunking desk-set 30, 32 to facilitate control of the trunking radio system 100. The trunking desk-sets 30, 32 communicate either directly with the trunking radio system 100 (i.e., local trunking desk-set 30), or, as shown in FIG. 4, through a termination panel 34 (i.e., remote trunking desk-set 32) via a subscriber unit 14. The termination panel 34 decodes the tone sequence generated by the remote trunking desk-set 32, and outputs a digital control signal to the subscriber unit 14. The subscriber unit 14 then communicates wirelessly to the trunking radio (which comprises trunking repeaters 6 and a trunking controller 12 (not shown in FIG. 4)). This is a typical scenario when the trunking radio base station is physically separated from the dispatcher (perhaps in a different building) and no physical lines have been installed to connect the remote trunking desk-set 32 and the trunking radio base station. The local trunking desk-set 30 communicates to the trunking radio via a subscriber unit 14 in a similar manner. The termination panel 34 is not needed with the local trunking desk-set 30, because the local trunking desk-set 30 has the appropriate digital outputs to control the subscriber unit 14.

Trunking desk-sets 30, 32 and termination panel 34 are typically proprietary devices. These are devices that can communicate with only one type of trunking radio system 100. In addition, the dispatch operator now must manage two devices to communicate over the entire radio system (trunking desk-sets and consoles). Further, the functions of each dispatch device are not interrelated and, thus, operation becomes complicated for one operator.

Thus, a need exists for a bridge between conventional consoles 22 and a trunking radio system 100, to eliminate purchases and additions of costly trunking desk-sets 30, 32 for multiple users of a new trunking radio system 100. Additionally, a bridge is needed between trunking desk-sets 30, 32 of an older trunking radio system 100 and a newer trunking radio system 100.

### SUMMARY OF THE INVENTION

It is therefore a general object of the invention to provide a system and method for controlling a new trunking radio system by trunking desk-sets of an older trunking radio system and/or consoles of an older conventional radio system to obviate or minimize problems of the type previously discussed.

The trunking tone remote adapter will bridge this gap by allowing a conventional tone remote channel of the dispatch console to control a trunked radio using the standard tone sequence that is used for tone remote control in conventional systems today. This will allow the addition of trunked radio channels into a conventional dispatch system in a manner that is practically transparent to the dispatch operator. Now the system can capitalize on the advantages of a trunked radio without the addition of new dispatch equipment, additional burden on the dispatch operator or additional training.

In accordance with an embodiment of the present invention, a method is disclosed for operating a trunking radio system by a console for a conventional radio system, wherein the steps comprise defining a system/group table in a trunking tone remote adapter, receiving at the trunking tone remote adapter a tone sequence from at least one of the console, local desk-set or a remote desk-set, and decoding a function tone at the trunking tone remote adapter from the tone sequence. The method for operating trunking radio system by a console for a conventional radio system further comprises mapping the function tone received from the console to the defined system/group table to determine the executable function by the trunking tone remote adapter and controlling the trunking radio system according to the executable function by the trunking tone remote adapter.

In accordance with other aspects of the present invention, a trunking radio system comprises a console for controlling a conventional radio system and a trunking tone remote adapter for controlling the trunking radio system. The trunking tone remote adapter comprises a memory adapted to define a system/group table and a controller adapted to receive a tone sequence from a console, to decode a function tone from the tone sequence, to map the function tone received from the console to the defined system/group table, to determine the executable function, and to control the trunking radio system according to the executable function.

### BRIEF DESCRIPTION OF THE DRAWINGS

The various objects, advantages and novel features of the present invention will be best understood by reference to the detailed description of the preferred embodiments which follows, when read in conjunction with the accompanying drawings, in which:

FIG. 1 is a block diagram of a typical trunking radio system;

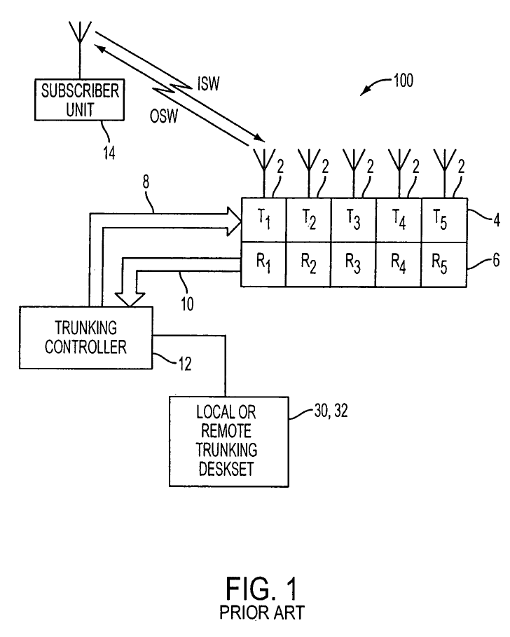

FIG. 2 is a block diagram of a typical conventional radio system;

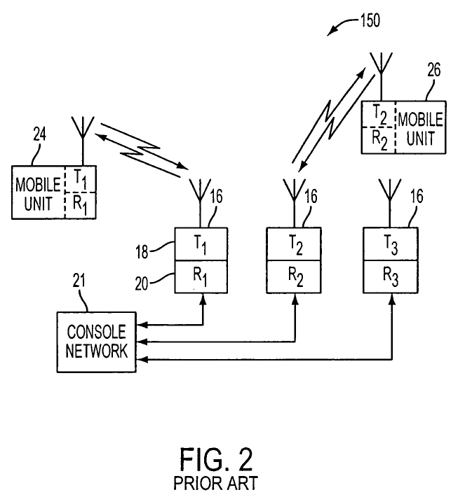

FIG. 3 is a block diagram of conventional radio system utilizing a trunking remote adapter;

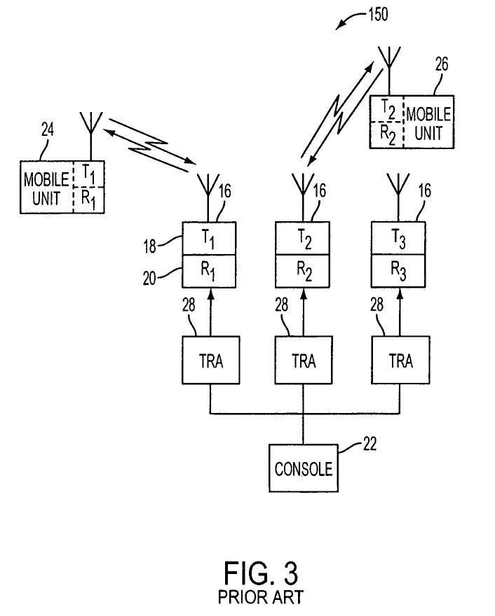

FIG. 4 is a block diagram of the conventional radio system and the trunking radio system of FIG. 1, whereby local and remote trunking desk-sets are added to the combined radio systems;

FIG. 5 is a block diagram of a combination trunking and conventional radio system using a trunking tone-remote adapter according to a first embodiment of the present invention;

FIG. 6 is a block diagram of a trunking radio system using a trunking tone-remote adapter and a local control device according to a second embodiment of the present invention;

FIG. 7 is a flow diagram illustrating a method for controlling a trunking radio system using a trunking tone-remote adapter with either consoles from a conventional radio system or trunking desk-sets from an older trunking radio system in accordance with an embodiment of the present invention; and

FIG. 8 is a schematic block diagram of the trunking tone remote adapter according to an embodiment of the present invention.

### DETAILED DESCRIPTION OF THE PREFERRED EMBODIMENTS

The various features of the preferred embodiments will now be described with reference to the drawing figures, in which like parts are identified with the same reference characters. The following description of the presently contemplated best mode of practicing the invention is not to be taken in a limiting sense, but is provided merely for the purpose of describing the general principles of the invention.

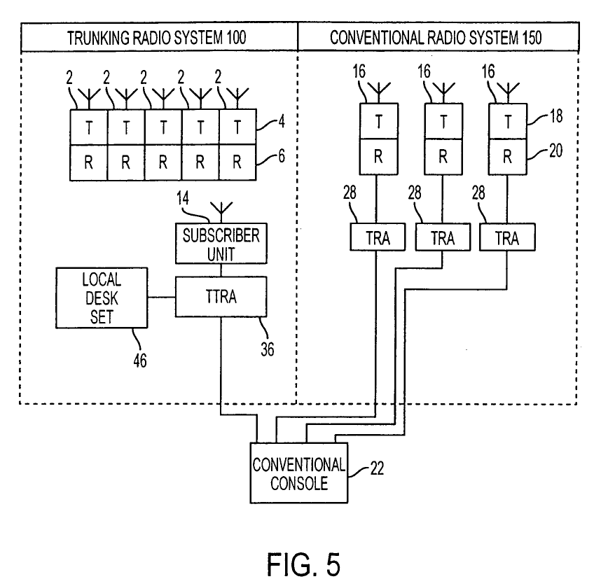

FIG. 5 is a block diagram of a combination trunking and conventional radio system using a trunking tone remote adapter (TTRA) 36 according to a first embodiment of the present invention. The trunking tone remote adapter 36 allows a conventional console 22 to control a trunking radio system 100 using the standard tone sequence that is used for tone remote control in conventional radio systems 150. This allows the addition of a trunking radio system 100 to a conventional radio system 150 to be practically transparent to the dispatch operator. With the implementation of a trunking tone remote adapter 36, the combined radio system can capitalize on the advantages of a trunking radio system 100 without the addition of new dispatch equipment (trunking desk-sets 30, 32), or additional training for the dispatch operator.

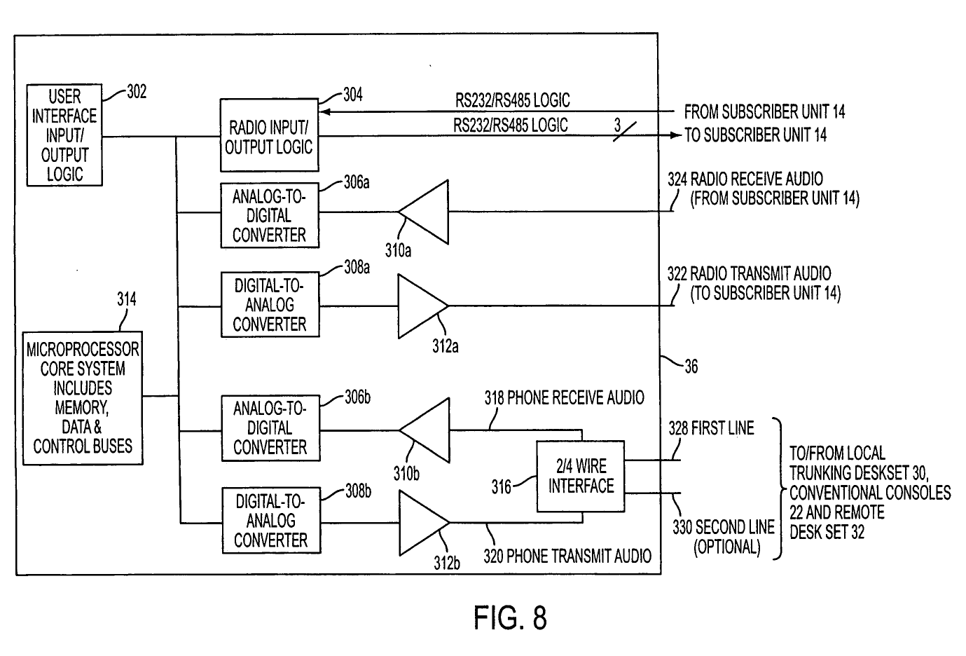

FIG. 8 is a schematic block diagram of the trunking tone remote adapter 36 according to an embodiment of the present invention. The trunking tone remote adapter 36 is designed and manufactured with components generally used in devices of this nature, as is well known to those skilled in the art. This includes, for example, I/O circuitry (to receive digital and RF signals, and demodulate the latter), microprocessor(s), memory (temporary (RAM) and/or permanent (hard drive, floppy drive PROMs), data and control buses, operator-interface devices and power supplies, among others. The assembly and interconnect of these devices is well known to those skilled in the art, and will not be repeated here.

FIG. 8 illustrates a schematic block diagram of the trunking tone remote adapter 36. The trunking tone remote adapter 36 preferably uses, but is not limited to, a digital signal processor (DSP) for accurate and fast control tone encoding/decoding and audio filtering. The user interface input/output logic block 302 of FIG. 8 comprises several active and passive devices including, but not limited to, LED indicators, push buttons and program switches used to control several operational aspects of the trunking tone remote adapter 36. In another embodiment of the present invention, the program switches can be replaced with a nonvolatile memory that is programmed to control the operational aspects of the trunking tone remote adapter 36. The user interface of the trunking tone remote adapter 36 is simplistic in this implementation, but could, however, be easily modified to include other types of devices to suit the specific user application.

The microprocessor core system 314 comprises several active and passive devices that allows the processing of audio and the generation and detection of control tone sequences and signals to control the input and output logic circuitry (part of block 302). Control tone sequences are received by the microprocessor core system 314 from conventional consoles 22, the local desk-set 30 or remote desk-set 32. There are control tone sequences that microprocessor core system 314 outputs to the conventional consoles 22, the local desk-set 30 or remote desk-set 32.

Control tone sequences and phone-line audio from the remote dispatch devices 10 are received from the first phone line 328 (or the second phone line 330, as appropriate) and routed to the 2/4 wire interface 316, phone-line gain compensation circuitry 310b and the analog-to-digital converter 306b, where the audio is digitized for processing by the microprocessor core system 314. The microprocessor core system 314 analyzes the received phone-line audio for a valid control tone sequence and performs certain operations based on the received tone. These operations are well known to those skilled in the art.

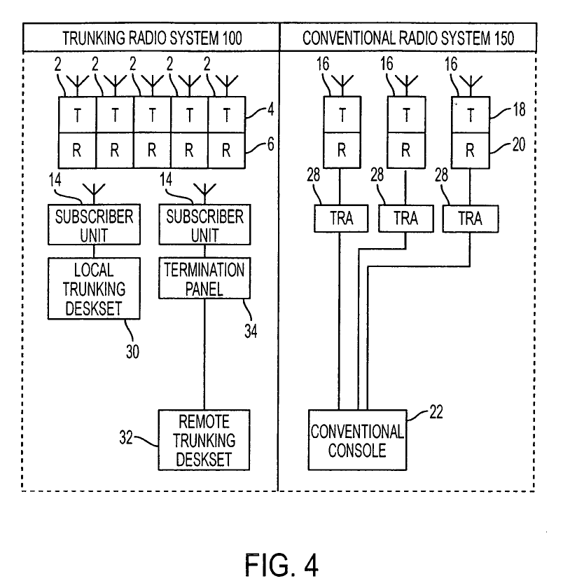

The combination trunking and conventional radio system illustrated in FIG. 5 is identical to that illustrated in FIG. 4, except there is no remote trunking desk-set 32 or termination panel 34. Further, the local trunking desk set 30 is a local desk set 46. By using the trunking tone remote adapter 36 according to a first embodiment of the present invention, the remote trunking desk-set 32, termination panel 34 and one of the subscriber units are not needed. Therefore, an organization can install a new trunking radio system 100 using the existing dispatch equipment (console 22) without having to purchase new, expensive local or remote trunking desk sets 30, 32 and provide the training needed to learn how to use them.

The trunking tone remote adapter 36 according to a first embodiment of the present invention includes, instead of logic controls, RS232, RS485, TTL and other types of data ports that can be used for radio control. Therefore, the trunking tone-remote adapter 36 can control the trunking radio system 100 with a conventional tone-remote console 22 or a local desk-set 46. Users of existing conventional radio systems 150 can replace, or augment, the conventional radio systems 150 with a trunking radio system 100 and exploit the full functionality of the features of their conventional tone-remote console 22 while using the trunking radio system 100. Like a conventional tone-remote adapter, the trunking tone-remote adapter 36 can not only decode the standard 16 EIA function tones, but can also provide a user of the trunking radio system 100 with the ability to create and control up to 16 system and group combinations, using their conventional tone remote consoles 22. With the addition of a second function tone, it is know by those versed in tone remote control, that it is possible to control up to 256 system and group combinations. However, this type of tone control is not typical nor standard.

Since the trunking tone-remote adapter 36 communicates with, and controls the trunking radio system 100 via an RS232, RS485, TTL or other types of data ports, the need for local I/O is low. However, this capability can be retained as desired. In one embodiment of the present invention, retaining local I/O control in the trunking tone remote adapter 36 provides at least five outputs that indicate the selected channel and push-to-talk (PTT) function.

As discussed above, the trunking tone-remote adapter 36 can decode the 16 EIA function tones (received from conventional console 22), which range from about 550 Hz to about 2050 Hz, and can also decode the guard tone of about 2175 Hz. To decode a function tone, the trunking tone-remote adapter 36 receives a tone sequence (a high-level guard tone, a function tone, and possibly a low-level guard tone), and determines the frequency (i.e., decodes) of each received tone. Upon decoding the function tone, and determining which one has been received, the trunking tone-remote adapter 36 references a preprogrammed system/group table (e.g., Table I, shown below) to determine which system and group to steer the trunking radio to. “Group” refers to talk groups discussed in detail above. “System” is defined as a group of groups. Therefore, for example, when a 750 Hz function tone is generated, the trunking radio system 100 will cause the trunking radio system 100 to tune to group 1, and system 5. see Table I. System 5 could comprise, for example, groups 2, 3 and 4. The system/group table is determined by the user during installation, and can be programmed into the trunking tone-remote adapter 36 at that time, or re-programmed at a later time. In addition, the system/group table includes entries for locally connected equipment such as a local desk-mic, a local accessory, and a system/group for use during supervisor override. When a push-to-talk (PTT) assertion is detected from the local desk-mic or local accessory, the trunking tone-remote adapter 36 references the proper entry in the preprogrammed system/group table to determine which system and group to steer the trunking radio to. Further, when the supervisor override function is asserted, the trunking tone-remote adapter 36 references the supervisor entry in the preprogrammed system/group table to determine which system and group to steer the radio to. An example of this table is shown in Table I below. The conventional monitor frequency of 2050 Hz would be considered F16 since a monitor is not required in a trunking radio system.

TABLE I

| | Function Tone (Hz) | System | Group |
|---|---|---|---|
| 1 | 550 | 1 | 1 |
| 2 | 650 | 1 | 2 |
| 3 | 750 | 5 | 1 |
| 4 | 850 | 5 | 2 |
| 5 | 950 | 5 | 3 |
| 6 | 1050 | 6 | 3 |
| 7 | 1150 | 7 | 4 |
| 8 | 1250 | 2 | 1 |
| 9 | 1350 | 2 | 2 |
| 10 | 1450 | 2 | 3 |
| 11 | 1550 | 2 | 4 |
| 12 | 1650 | 8 | 5 |
| 13 | 1750 | 8 | 3 |
| 14 | 1850 | 8 | 1 |
| 15 | 1950 | 50 | 65 |
| 16 | 2050 | 52 | 1 |
| 17 | Desk-Mic | 1 | 1 |
| 18 | Accessory Transmit | 10 | 1 |
| 19 | Supervisor Control | 1 | 1 |

As discussed above, the trunking tone-remote adapter 36 is configured to allow other devices, such as a desk-mic and an accessory, to transmit through it. In addition, supervisory control of the trunking tone-remote adapter 36 provides that, when activated, the supervisor can disallow transmissions from remote consoles 22 (or remote trunking desk-sets 32) through the trunking tone-remote adapter 36 or via a locally connected accessory.

The trunking tone-remote adapter 36 can be used as a dispatch point by attaching a desk-mic. The desk-mic is connected to a desk-mic jack on the front of the TTRA 36. The TTRA A 36 senses a PTT and steers the radio to the proper system/group and then provides the necessary control signals to assert the PTT on the radio. The operator can then press the desk-mic PTT to transmit on the trunking radio system 100. Since it is typically not possible for the dispatch operator to change the channel of the radio, the trunking tone-remote adapter 36 includes an entry in the programmable system/group table that is selected when the desk-mic PTT is asserted. See Table I, item No. 17. Selection of the this table entry steers the radio to the proper system and group followed by an assertion of the desk-mic PTT. When the operator releases the desk-mic PTT, the trunking tone-remote adapter 36 will, if not in supervisory mode, return to the previously selected system and group.

The trunking tone-remote adapter 36 includes an accessory port that allows the connection of other conventional dispatch devices such as another local trunking desk-set or, a radio-telephone interconnect or essentially any audio-generating device that can assert PTT using logic, a conventional tone-remote adapter or DC-remote adapter. Transmit operation of the accessory is generally described in the desk-mic operation, but with an additional entry in the system/group steer table for accessory transmits. See Table I, item No. 18. As in the desk-mic operation, the trunking tone-remote adapter 36 will, if not in a supervisory mode, return to the previously selected system and group. In either of these applications, the TTRA 36 can sense the logical PTT assertion, steer the radio to the proper system/group and then provide the necessary control signals to assert PTT on the radio.

Supervisory operation is entered when a user presses the supervisor button on the front of the trunking tone-remote adapter 36. When a user presses the supervisor button, the trunking tone-remote adapter 36 enters a supervisory mode and steers the radio to the system and group as programmed in the supervisor location of the system/group table. See Table I, item No. 19. As long as the trunking tone-remote adapter 36 is in supervisor mode, the same system/group will be selected. Upon exit of supervisor mode, the trunking tone-remote adapter 36 will return to the previously selected system and group. The supervisor mode prevents any channel steers or transmissions from either the trunking tone-remote adapter 36 or any attached accessory. This mode can be used to transmit from the trunking tone-remote adapter 36 for maintenance or emergency purposes while ensuring that the selected system/group does not change. No other device, with the exception of the desk-mic, can transmit.

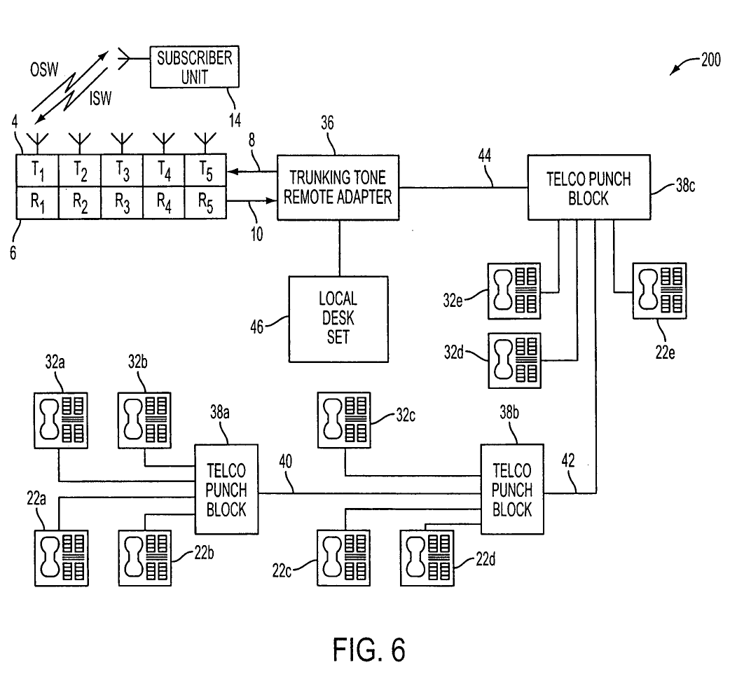

FIG. 6 illustrates a second embodiment of the present invention wherein a typical set-up of a trunking radio system 200 also employs the trunking tone-remote adapter 36 in a facility in which there can be at least one remotely located user. Trunking radio system 200 is preferably used in a land-mobile radio dispatch applications, such as campus security at a college, cities (police, fire, rescue), land-management (National Park and Forest Rangers), large scale manufacturers (oil refineries, steel mills, automotive manufacturers), and other applications, including any that require communications over significant distances or within a selected area, such as in and around a building.

Trunking radio system 200 comprises a trunking tone remote adapter 36, an optional local desk-set 46, a trunking radio (comprised of at least one or more paired transmitters 4 and receivers 6), and can further comprise remote trunking desk-sets 32a-32e and remote dispatch consoles (consoles) 22a-22e connected via telephone company punch blocks (punch blocks) 38a-38c.

Operation of a trunking radio system has been discussed above in detail, and this discussion will be omitted for brevity in regard to FIG. 6. As shown, trunking radio system 200 comprises both a local desk set 46, and remote trunking desk-sets 32a-32e (which are generally used in trunking radio systems) and consoles 22a-22e (which are generally used in conventional radio systems (also discussed in greater detail above)). The trunking radio system 200 is similar to that of the system shown and described in reference to FIG. 5, except there is a no conventional radio system 150 in the system of FIG. 6. Since control of the trunking radio system 200 is desired without having to replace all of the consoles 22 with new, expensive trunking desk-sets 30, 32 (and the expensive training to operate the new, expensive desk-sets), the trunking tone remote adapter 36 has been added. Some additional dispatch positions have been created, however, and those positions have implemented remote trunking desk-sets 32a-32e. Installation of the trunking tone remote adapter 36 allows dispatch operators of either the older consoles 22a-22e, or the relatively newer local or remote trunking desk sets 30, 32, to control the trunking radio system 200.

Telco-punch blocks (punch blocks) 38a-38c consolidate the lines that connect the remote trunking desk-sets 32a-32e and consoles 22a-22e to the trunking tone remote adapter 36 or other upstream punch blocks 38. For example, each punch block 38 consolidates four lines into a single line. Punch block lines 40, 42 and 44 can be privately controlled wires (i.e., “in-house” wiring), or leased telephone lines. In that way, the remote trunking desk-sets 32a-32e and consoles 22a-22e can be remotely located from the trunking tone remote adapter 36 and yet communicate with it via ordinary leased lines. The lines from each trunking desk-set 32a-32e and consoles 22a-22e can be either a 2-wire or 4-wire line. These lines carry the control tone sequence signals between the trunking desk-sets 32a-32e and consoles 22a-22e, trunking tone remote adapter 36 and local trunking desk-set 32. The lines and blocks can be collectively referred to as a network. This network can be comprised of interconnected pairs of wire, leased telephone lines or a local or wide area network (LAN, WAN).

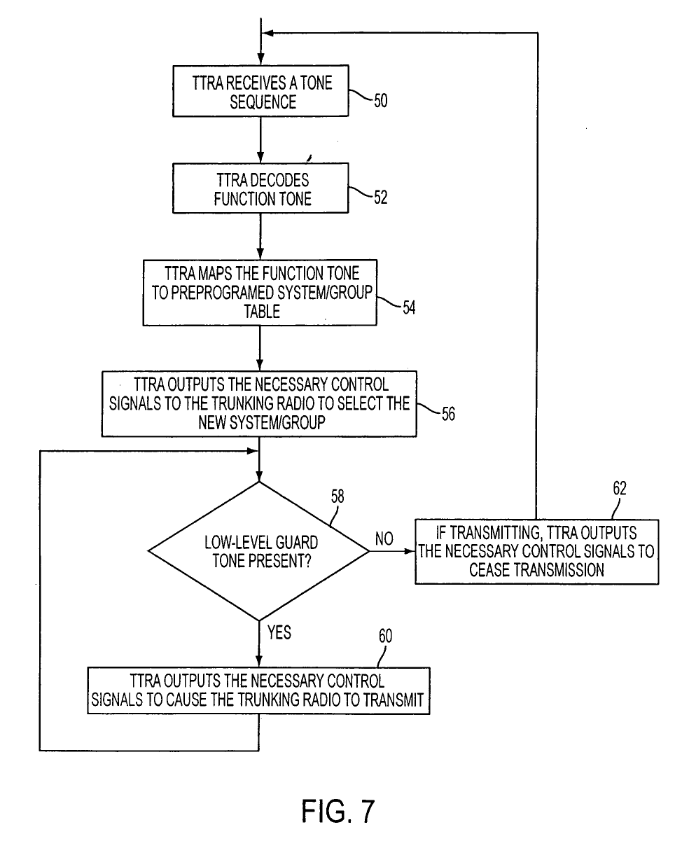

FIG. 7 is a flow diagram illustrating a method for controlling a trunking radio system 100 using a trunking tone remote adapter 36 with either consoles 22 from a conventional radio system 150, a local desk set 46, or local or remote trunking desk sets 30, 32 from a trunking radio system 100 according to an embodiment of the present invention. The method described in reference to FIG. 7 is used in the radio systems shown and described in reference to FIGS. 5 and 6, and describes how the trunking tone remote adapter 36 receives command signals from the trunking desk-sets 30, 32 and/or consoles 22, interprets the command signals, and then outputs an appropriate command to the trunking radio system 150 in a format it can understand.

The method for operating a trunking radio system 150 begins with step 50, in which the trunking tone remote adapter 36 receives a tone sequence from either a local desk set 46, or local or remote trunking desk sets 30, 32 or a console 22. The tones, as discussed above, are generated in response to certain actions performed at either the local desk set 46, or local or remote trunking desk sets 30, 32 or console 22 by the dispatch operator. The tone sequence comprises a high-level guard tone, a function tone, and, if a transmit function is desired, a low-level guard tone. Decoding extracts the function tone from the tone sequence, so that the trunking tone remote adapter 36 can recognize the transmitted function tone. In step 52, the trunking tone remote adapter 36 decodes the function tone. As discussed above, there are 16 separate tones, ranging from about 550 Hz to about 2050 Hz, in about 100 Hz increments.

In step 54, the trunking tone remote adapter 36 maps the function tone received from either the a local desk set 46, or local or remote trunking desk sets 30, 32 or console 22, to the pre-programmed system/group table, in order to determine the appropriate “function” to execute. The “function” is the particular system and/or group to tune the trunking radio system to with respect to the function tone as desired by the particular dispatch operator of the a local desk set 46, or local or remote trunking desk sets 30, 32 or console 22 that sent the tone sequence. Upon determining the correct system/group setting for the received function tone, the trunking tone remote adapter 36, in step 56, outputs the necessary control signals to the trunking radio system to select the new system/group.

In decision step 58, the trunking tone remote adapter 36 determines whether a low-level guard tone is present. The presence of a low-level guard tone indicates whether the dispatch operator wants to transmit to the particular system/group selected as a result of the controls the dispatch operator manipulated (and subsequent tone sequence was generated and transmitted to the trunking tone remote adapter 36). If a low-level guard tone is present (“Yes” path from decision step 58), the trunking tone remote adapter 36 outputs the necessary control signals to cause the trunking radio system to transmit (step 60). Following step 60, the trunking tone remote adapter 36 continues to monitor for the presence of the low-level guard tone, and thus returns to step 58. The trunking tone remote adapter 36 continues to monitor for the low-level guard tone and output the necessary control signals to cause transmission.

If a low-level guard tone is not present, or become “not present” (i.e., ceases to be present after being present), the trunking tone remote adapter 36 further determines whether the trunking radio system is already transmitting. If it is, then the trunking tone remote adapter 36 outputs the necessary control signals to cease transmission. This would occur if the method had previously performed decision step 58 and step 60, and was looping between the two steps (i.e., during transmission from a dispatch operator). Of course, if the trunking tone remote adapter 36 determines no transmission is taking place, no output signals need to be output to cause the transmitter to cease transmission. Following the decision of whether the trunking radio system is transmitting (in step 62), the method returns to step 50, and monitors the input control lines to receive the next tone sequence.

The present invention has been described with reference to several exemplary embodiments. However, it will be readily apparent to those skilled in the art that it is possible to embody the invention in specific forms other than that of the exemplary embodiments described above. This may be done without departing from the spirit of the invention. The exemplary embodiments are merely illustrative and should not be considered restrictive in any way. The scope of the invention is given by the appended claims, rather than the preceding description, and all variations and equivalents which fall within the range of the claims are intended to be embraced therein.

1. A method for operating a trunking radio system by a console for a conventional radio system, comprising:
defining a system/group table in a trunking tone remote adapter;
receiving at the trunking tone remote adapter a tone sequence from at least one of the console, local desk-set or a remote desk-set;
decoding a function tone at the trunking tone remote adapter from the tone sequence;
mapping the function tone received from the console to the defined system/group table to determine the executable function by the trunking tone remote adapter; and
controlling the trunking radio system according to the executable function by the trunking tone remote adapter.

2. The method for operating a trunking radio system according to claim 1, wherein the step of controlling the trunking radio system according to the executable function by the trunking tone remote adapter comprises:
outputting control signals by the trunking tone remote adapter to the trunking radio to execute the mapped function;
determining whether a low-level guard tone is present in the tone sequence and outputting transmit control signals if the low-level guard tone is present, or monitoring for the presence of additional tone sequences if the low-level guard tone is not; and
repeating the steps of determining and outputting as long as the low-level guard tone is present.

3. The method according to claim 1, wherein the step of defining a system/group table in the trunking tone remote adapter comprises:
programming a system/group table so that the trunking tone remote adapter can map a received, decoded function tone to a desired system and group to which the trunking radio system should be tuned for communication purposes.

4. The method according to claim 1, further comprising:
asserting control of the trunking radio system by a supervisor such that the trunking tone remote adapter enters a supervisory mode, preventing any other attached console or local device from asserting control over the trunking radio system, and the trunking radio system remains tuned to the system/group as defined in the system/group table corresponding to supervisory control.

5. The method according to claim 4, wherein the local device comprises:
a desk-mic or accessory device.

6. The method according to claim 5, wherein the accessory device comprises:
a local trunking desk-set or radio-telephone.

7. The method according to claim 1, further comprising:
asserting control of the trunking radio system by a local device such that the trunking tone remote adapter is tuned to the system/group as defined in the system/group table corresponding to the local device.

8. The method according to claim 7, wherein the local device comprises:
a desk-mic or accessory device.

9. The method according to claim 8, wherein the accessory device comprises:
a local trunking desk-set or radio-telephone.

10. A method for operating a new trunking radio system by a desk-set of an older trunking radio system or a console of a conventional radio system wherein the method comprises:
defining a system/group table in a trunking tone remote adapter;
receiving at the trunking tone remote adapter a tone sequence from the console;
decoding the tone sequence at the trunking tone remote adapter from the tone sequence;
mapping the function tone received from the console to the defined system/group table to determine the executable function by the trunking tone remote adapter; and
controlling the trunking radio system according to the executable function by the trunking tone remote adapter to obviate needing a new trunking radio system desk-set or training to use the new trunking radio system.

11. A trunking tone remote adapter for controlling a trunking radio system comprising:
memory adapted to define a system/group table; and
a controller adapted to receive a tone sequence from a console, to decode a function tone from the tone sequence, to map the function tone received from the console to the defined system/group table, to determine the executable function, and to control the trunking radio system according to the executable function.

12. The trunking tone remote adapter for controlling a trunking radio system according to claim 1, wherein:
the controller is further adapted to output control signals to the trunking radio system to execute the mapped function, to determine whether a low-level guard tone is present in the tone sequence and output transmit control signals if the low-level guard tone is present, or monitor for the presence of additional tone sequences if the low-level guard tone is not, and to repeat the determination of the presence of the low-level guard tone and output the transmit control signal as long as the low-level guard tone is present.

13. The trunking tone remote adapter for controlling a trunking radio system according to claim 1, wherein the system/group table in the console comprises:
a map between a received, decoded function tone and a desired system and group to which the trunking radio system should be tuned for communication purposes.

14. The trunking tone remote adapter for controlling a trunking radio system according to claim 1, wherein:
the controller is further adapted to allow a supervisor to assert control of the trunking radio system such that the trunking tone remote adapter enters a supervisory mode, prevents any other attached console or local device from asserting control over the trunking radio system, and the trunking radio system remains tuned to the system/group as defined in the system/group table corresponding to supervisory control.

15. The trunking tone remote adapter for controlling a trunking radio system according to claim 14, wherein the local device comprises:
a desk-mic or accessory device.

16. The trunking tone remote adapter for controlling a trunking radio system according to claim 15, wherein the accessory device comprises:
a local trunking desk-set or radio-telephone.

17. The trunking tone remote adapter for controlling a trunking radio system according to claim 1, wherein:
the controller is further adapted to assert control of the trunking radio system by a local device such that the trunking tone remote adapter is tuned to the system/group as defined in the system/group table corresponding to the local device.

18. The trunking tone remote adapter for controlling a trunking radio system according to claim 17, wherein the local device comprises:
a desk-mic or accessory device.

19. The trunking tone remote adapter for controlling a trunking radio system according to claim 18, wherein the accessory device comprises:
a local trunking desk-set or radio-telephone.

20. A trunking radio system comprising:
a console for controlling a conventional radio system; and
trunking tone remote adapter for controlling the trunking radio system, wherein the trunking tone remote adapter comprises:
a memory adapted to define a system/group table; and
a controller adapted to receive a tone sequence from a console, to decode a function tone from the tone sequence, to map the function tone received from the console to the defined system/group table, to determine the executable function, and to control the trunking radio system according to the executable function.
